(19) United States
(12) Patent Application Publication
(10) Pub. No.: US 2024/0243508 A1
(43) Pub. Date: Jul. 18, 2024

(54) CONNECTOR FEMALE END PIECE FOR PREVENTING TERMINALS FROM FALLING OFF AND CONNECTOR THEREOF

(71) Applicant: Dongguan City Lingshang Photoelectric Science and Technology Co., Ltd., Donnguan (CN)

(72) Inventor: Xiao Xin Yuan, Dongguan (CN)

(21) Appl. No.: 18/153,357

(22) Filed: Jan. 12, 2023

(51) Int. Cl. H01R 13/436; H01R 13/11; H01R 13/506; H01R 13/639

(52) U.S. Cl. CPC H01R 13/4367; H01R 13/11; H01R 13/506; H01R 13/639; H01R 13/516

(57) ABSTRACT

A connector female end piece for preventing terminals from falling off and the connector thereof, the connector includes a female end housing and a female end terminal, the female end housing includes a female end terminal slot, a spring tab, the female end terminal is provided with an opening, a hook is disposed by the opening on the female end terminal, the side face of the hook is opposite to the side face of the spring tab, and the opening of the female end terminal is located under the spring tab of the female end housing, when the female end terminal is pulled outwards, the hook presses the spring tab down to engage with the opening of female end terminal, effectively preventing the female end terminal from being pulled out easily, the reliability and stability of connector are guaranteed, and the signals are transmitted smoothly.

### BACKGROUND OF INVENTION

### Field of the Invention

The invention relates to the technical field of connectors, in particular to a connector female end piece for preventing terminals from falling off and a connector thereof.

### Description of Related Art

With rapid development of computer network industries, the connector data line for data transmission becomes very important. The existing connectors are generally connected to other equipment by inserting the conductive terminal in the main body of connector and connecting the conductor to the conductive terminal. However, when the conductor is pulled by a strong external force, the conductive terminal is likely to be pulled out, leading to lose connection and poor stability, so that the signal transmission is influenced.

Therefore, a solution to the above problem is desired.

### SUMMARY OF THE INVENTION

The object of the present invention is to provide a connector female end piece and a connector thereof which prevent terminals from falling off in view of the deficiencies in the prior art. The purpose of the present invention can be achieved through the following technical solutions.

A connector female end piece for preventing terminals from falling off, comprising a female end housing and a female end terminal, wherein the female end housing includes a female end terminal slot, and an upper end of the female end housing has a spring tab, the spring tab is located above the female end terminal slot, the female end terminal is provided with an opening, the female terminal is provided with a hook on a side of the opening; the female terminal is inserted into the female terminal slot, the side of the hook is opposite to the side of the spring tab, and the opening of the female terminal is located below the spring tab of female end housing; when the female terminal is pulled out, the hook pushes against the spring tab to sink and engage with the opening of the female terminal.

More preferably, wherein the side of the hook and the side of the spring tab are inclined surfaces that match each other.

More preferably, wherein the female end housing includes a female end housing main body, a female end pin component and a spring tab housing, the female end pin component is disposed at a front end of the female end housing main body, the spring tab housing is disposed at a top end of the female end housing main body, the spring tab housing is provided with a female end terminal slot, the spring tab is installed on the spring tab housing.

A connector for preventing terminals from falling off, comprising a connector female end piece and a connector male end piece, wherein the connector female end piece is as described above, the connector male end piece includes a male end housing and a male end terminal, the male end terminal is assembled on the male end housing, the connector female end piece is inserted in the connector male end piece, and the male end housing presses against the spring tab and sinks to engage with the opening of female end terminal.

More preferably, wherein the male end housing includes a male end housing main body, the male end housing main body is provided with a pin slot and a spring tab housing slot, the spring tab housing slot is located at an upper end of the pin slot.

More preferably, the female end housing is provided with a locking piece, the locking piece is provided with a groove, the male end housing is provided with a locking block corresponding to the groove.

In comparison to the existing technology, the present invention has the following benefits:

The connector female end piece for preventing terminals from falling off and the connector thereof of the present invention, when the female end housing is inserted in the male end housing or the female end terminal receives an outward pulling force, the spring tab at the top end of female end housing goes down and presses the opening of female end terminal, effectively preventing the female end terminal from being pulled out easily. The reliability and stability of connector are guaranteed, so that the signals are transmitted smoothly.

### BRIEF DESCRIPTION OF THE DRAWINGS

FIG. 1 is a structural representation of the female end housing in the present invention;

FIG. 2 is a side view of the female end housing in the present invention;

FIG. 3 is a structural representation of the female end terminal in the present invention;

FIG. 4 is a structural representation of the connector female end piece in the present invention;

FIG. 5 is a structure decomposition diagram of the connector female end piece in the present invention;

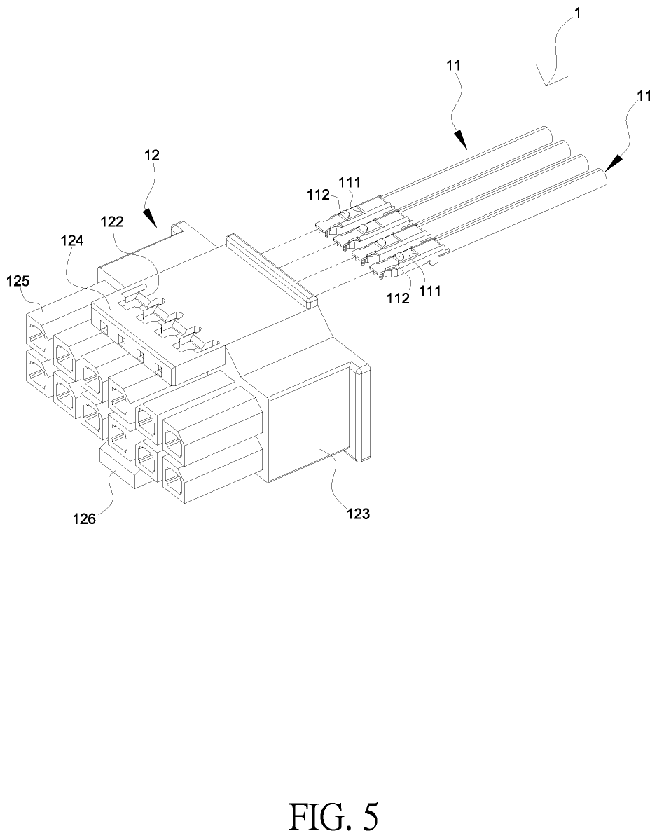

FIG. 6 is a structural diagram of a-a section in FIG. 4;

FIG. 7 is a schematic section of the connector female end piece when the female end terminal is unstressed in the present invention;

FIG. 8 is a schematic section of the connector female end piece when the female end terminal is stressed in the present invention;

FIG. 9 is a structural representation of the connector in the present invention;

FIG. 10 is a structural diagram of b-b section in FIG. 9;

FIG. 11 is a schematic section of the connector in the present invention;

FIG. 12 is a schematic section of the connector male end piece in the present invention.

### DETAILED DESCRIPTION OF THE INVENTION

Described with embodiment figures below.

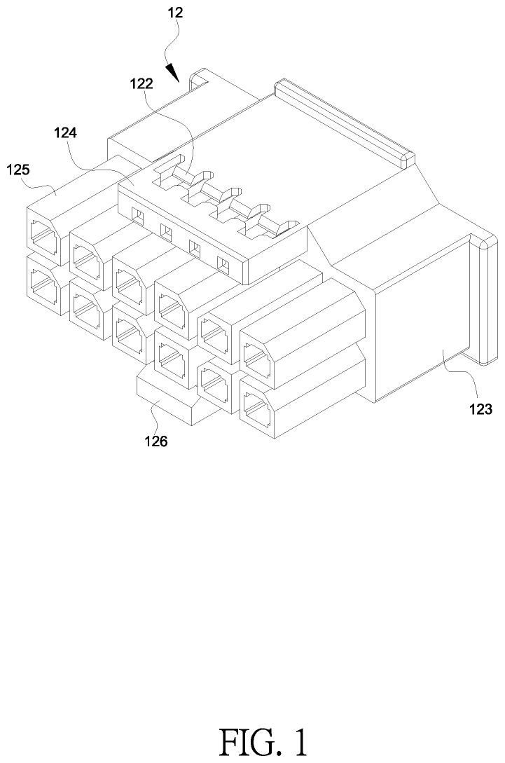

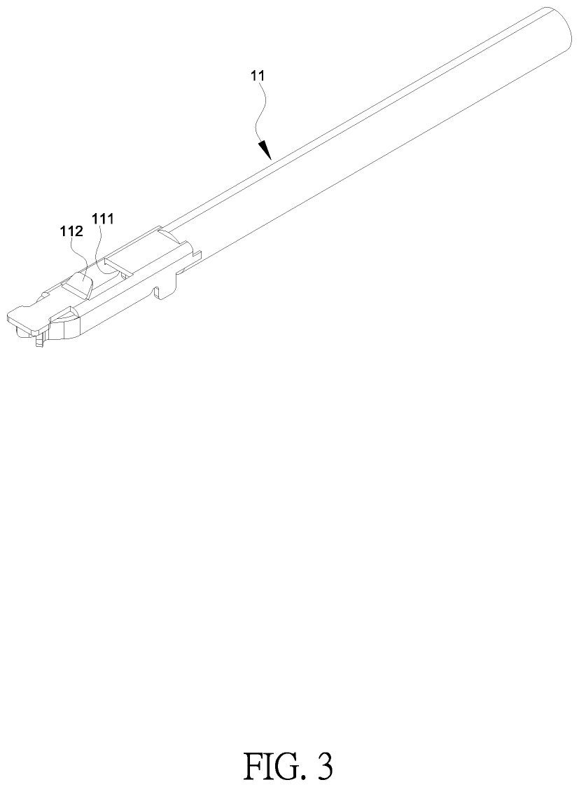

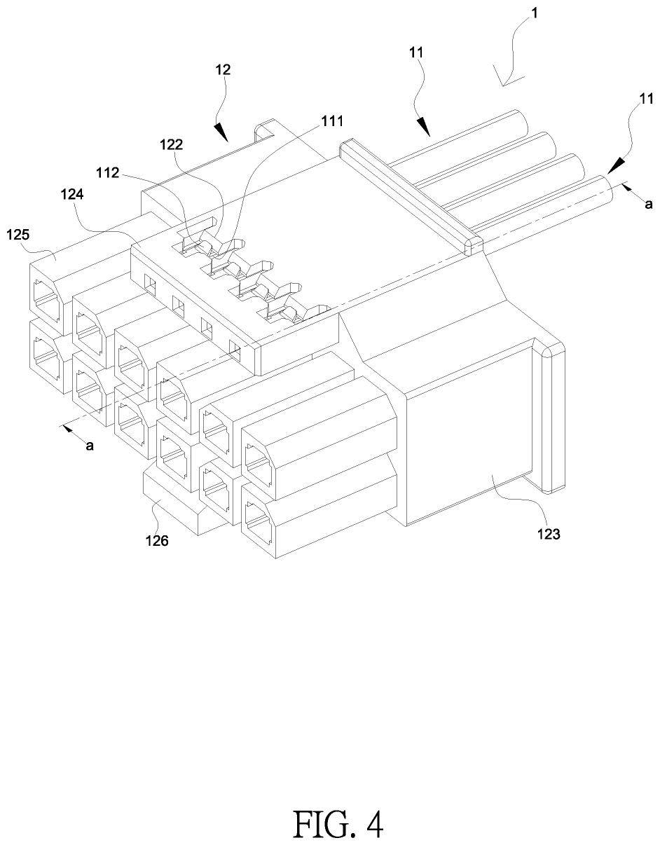

FIG. 1 to FIG. 4 show a connector female end piece for preventing terminals from falling off 1, including a female end housing 12 and a female end terminal 11. The female end housing 12 is provided with a female end terminal slot 121 for holding the female end terminal 11. A spring tab 122 is disposed at the upper end of the female end housing 12, the spring tab 122 is located above the female end terminal slot 121; as shown in FIG. 4 and FIG.

5, the female end terminal 11 is provided with an opening 111, the spring tab 122 of female end housing 12 can engage with the opening 111 of female end terminal 11 to implement positioning.

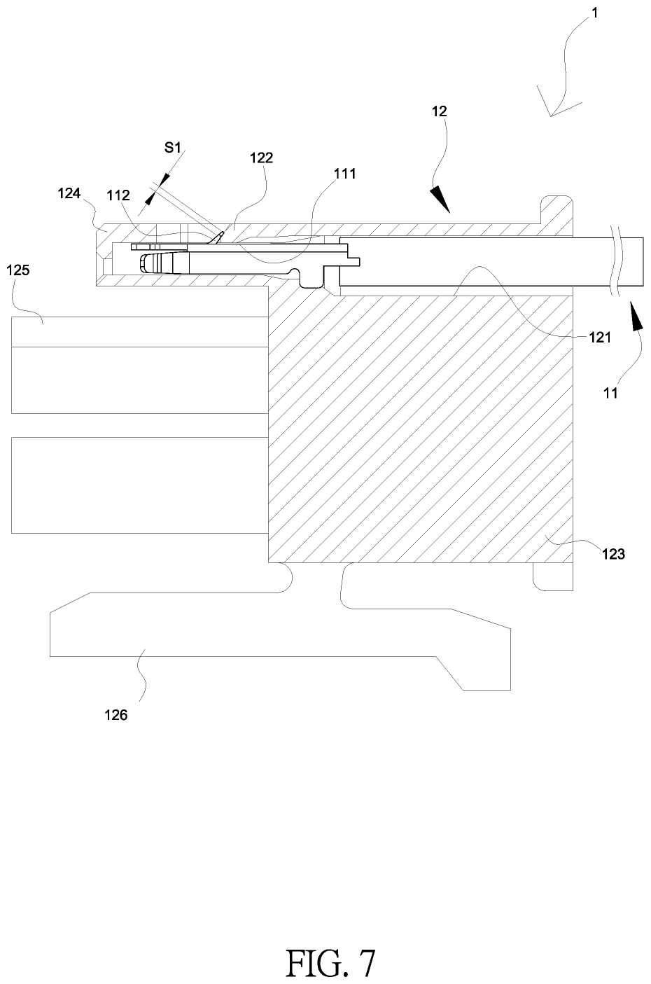

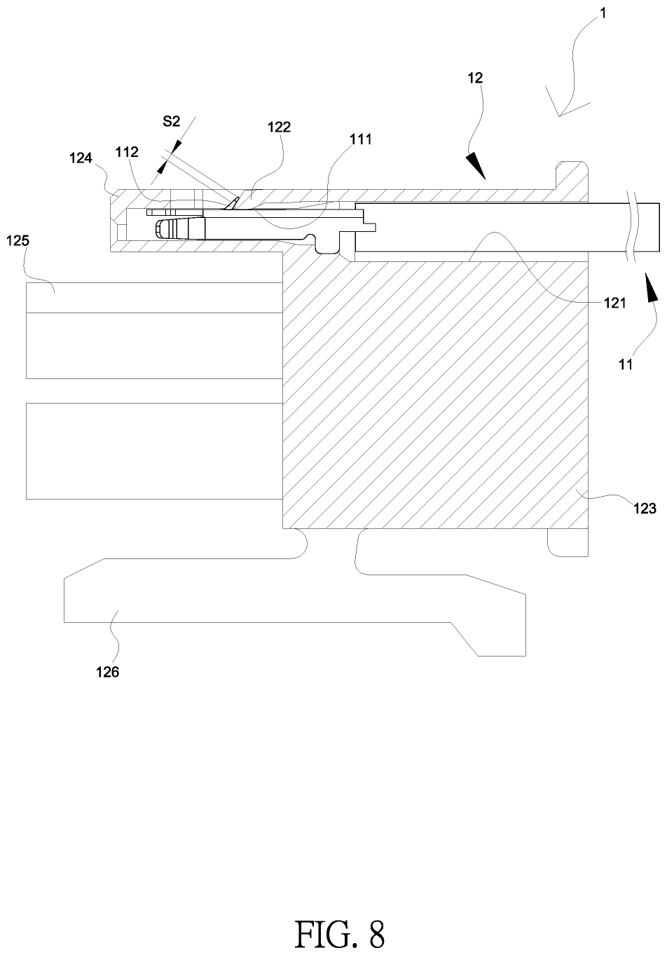

As shown in FIG. 7 and FIG. 8, a hook 112 is disposed by the opening 111 on the female end terminal 11, the female end terminal 11 is inserted in the female end terminal slot 121, the side face of the hook 112 is opposite to the side face of the spring tab 122, the opening 111 of the female end terminal 11 is located under the spring tab 122 of the female end housing 12, the hook 112 can press the spring tab 122 down to the opening 111 of female end terminal 11.

As shown in FIG. 8, when the female end terminal 11 is pulled outwards, the hook 112 presses the spring tab 122 down to engage with the opening 111 of the female end terminal 11.

A connector female end piece for preventing terminals from falling off provided in the present invention can increase the confining force in the connector female end piece manufacturing process.

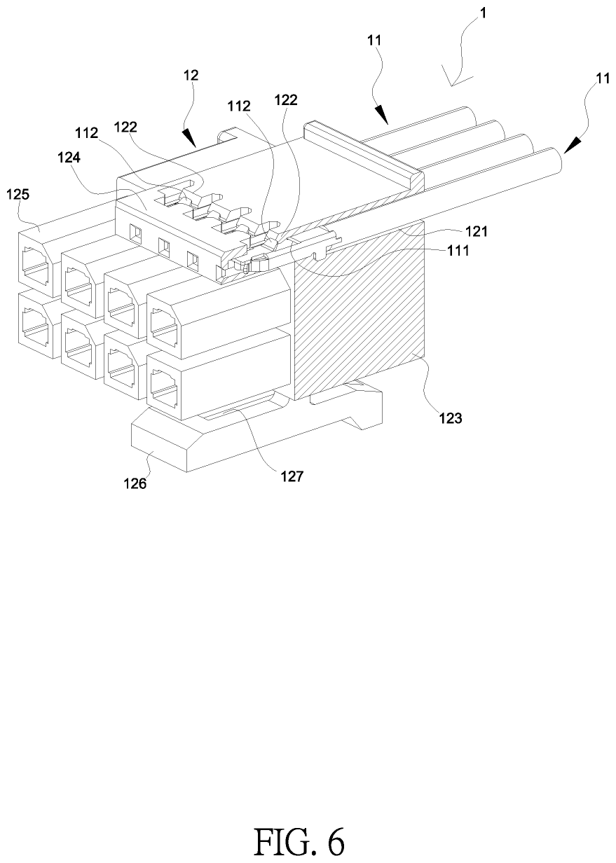

Specifically, as shown in FIG. 6, the female end terminal 11 is inserted in the female end terminal slot 121, when the female end terminal 11 is unstressed, the contact area of the hook 112 of female end terminal 11 and spring tab 122 is S1, as shown in FIG. 7.

When the female end terminal 11 receives an outward pulling force, the hook 112 of female end terminal 11 presses the spring tab 122 down to engage with the opening 111 of female end terminal 11, the contact area of the hook 112 of female end terminal 11 and spring tab 122 is S2, as shown in FIG. 8.

When the female end terminal 11 receives an outward pulling force, the contact area S2 of the hook 112 of female end terminal 11 and spring tab 122 is larger than the contact area S1 of the hook 112 of female end terminal 11 and spring tab 122 when the female end terminal 11 is unstressed, the spring tab 122 goes down and engages with the opening 111 of female end terminal 11, and the contact area is enlarged, so that the confining force of female end terminal 11 and spring tab 122 is increased, the female end terminal 11 is unlikely to escape from the female end housing 12, effectively preventing the female end terminal 11 from being pulled out easily, the reliability and stability of connector are guaranteed, the signals are transmitted smoothly.

FIG. 4 shows a connector female end piece for preventing terminals from falling off, the side face of the hook 112 and the side face of spring tab 122 are mutually matched bevel faces, when the female end terminal 11 receives an outward pulling force, as the side face of hook 112 and the side face of spring tab 122 are mutually matched bevel faces, under the pressure of the hook 112 of female end terminal 11, the spring tab 122 goes down smoothly along the side face of hook 112 to engage with the opening 111 of female end terminal 11, as shown in FIG. 8, so that the female end terminal 11 is unlikely to be pulled out.

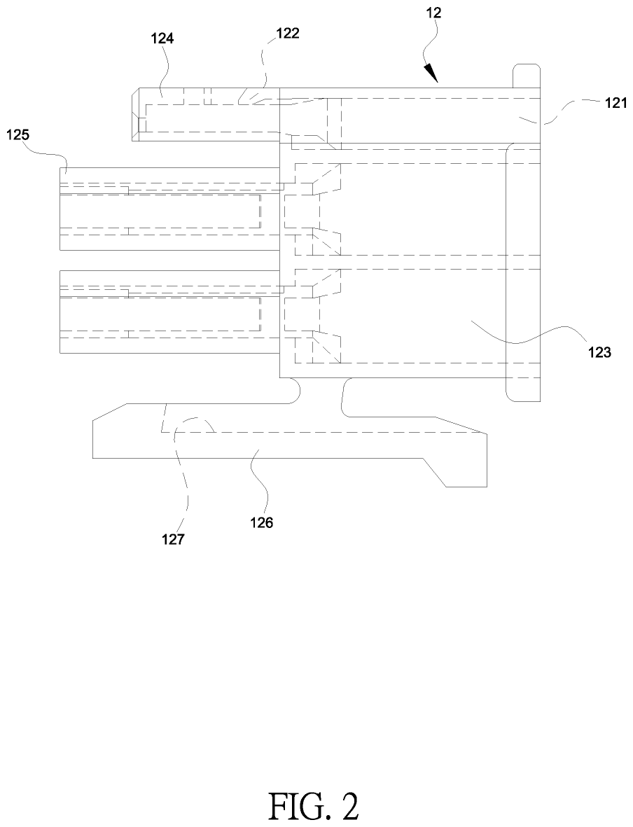

As shown in FIG. 1 and FIG. 2, the female end housing 12 includes a female end housing main body 123, a female end pin component 125 and a spring tab housing 124, the female end pin component 125 is disposed at the front end of the female end housing main body 123, the spring tab housing 124 is disposed at the top end of the female end housing main body 123, the spring tab housing 124 is provided with a female end terminal slot 121, the spring tab 122 is installed on the spring tab housing 124, so that it is convenient to insert the connector female end piece in the connector male end piece.

As shown in FIG. 6, when the connector female end piece 1 is inserted in the connector male end piece, the connector male end piece contacts the spring tab housing 124, and presses the spring tab 122 down into the female end terminal slot 121 to engage with the opening 111 of female end terminal 11, so as to confine the position of female end terminal 11.

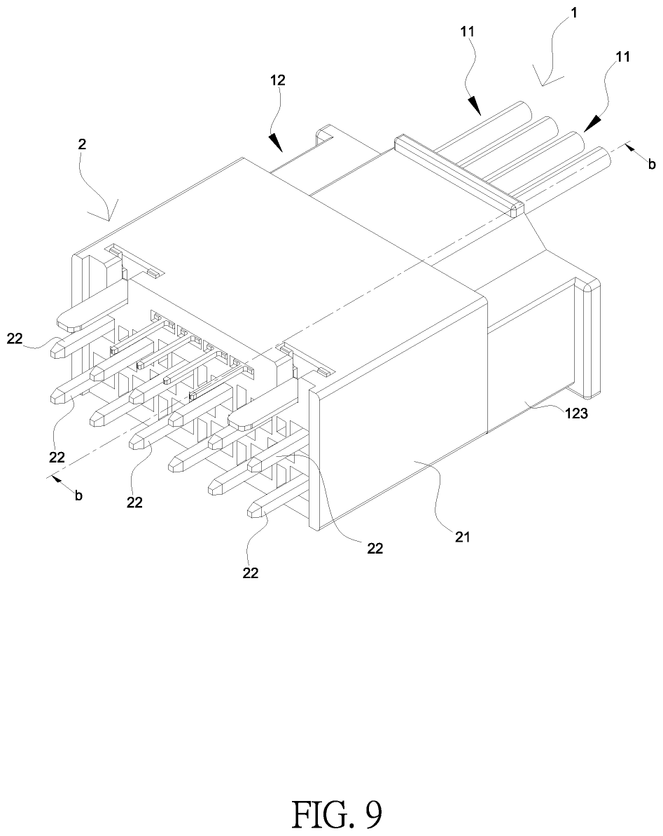

In addition, the present invention provides a connector preventing from falling off, as shown in FIG. 9 to FIG. 11, including a connector female end piece 1 and a connector male end piece 2, the connector male end piece 2 includes a male end housing 21 and a male end terminal 22, the male end terminal 22 is assembled on the male end housing 21, the structure of the connector female end piece 1 is stated above, the connector female end piece 1 is inserted in the connector male end piece 2, and the male end housing 21 presses the spring tab 122 down to engage with the opening 111 of female end terminal 11.

The confining force can be increased in the process of inserting the connector female end piece 1 in the connector male end piece 2, specifically, when the connector female end piece 1 is inserted in the connector male end piece 2, the connector male end piece 2 contacts the spring tab housing 124, and presses the spring tab 122 down into the female end terminal slot 121 to engage with the opening 111 of female end terminal 11, meanwhile the contact area of the hook 112 of female end terminal 11 and spring tab 122 is S2, the contact area can be enlarged, the confining force of female end terminal 11 and spring tab 122 is increased.

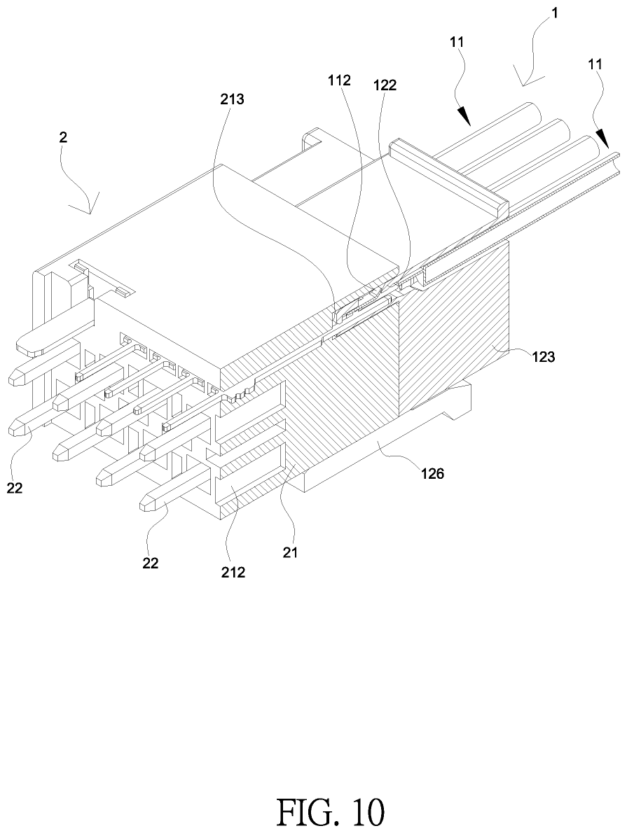

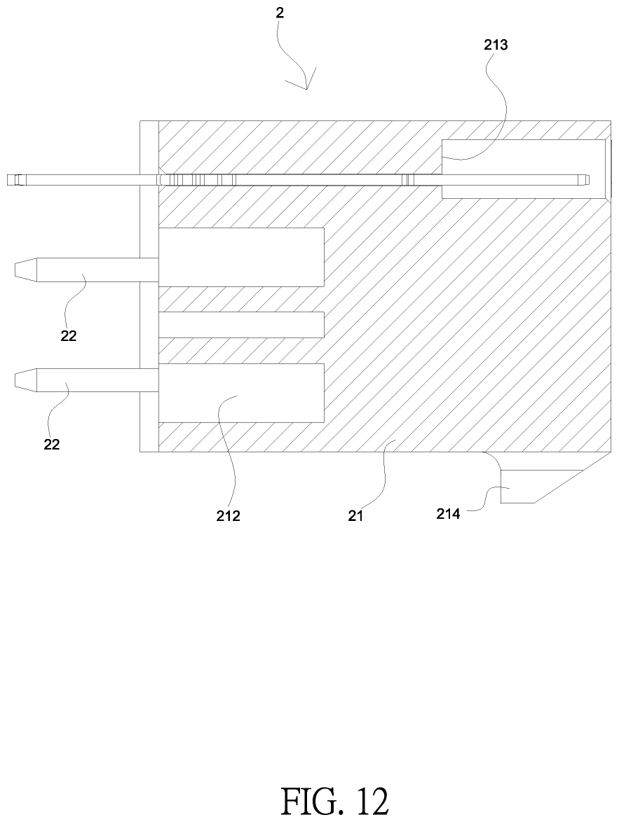

As shown in FIG. 12, in this case, the male end housing 21 includes a male end housing main body 211, the male end housing main body 211 is provided with a pin slot 212 and a spring tab housing slot 213, the spring tab housing slot 213 is located at the upper end of the pin slot 212, corresponding to the female end housing 12, convenient for quick inserting, as shown in FIG. 9 and FIG. 10.

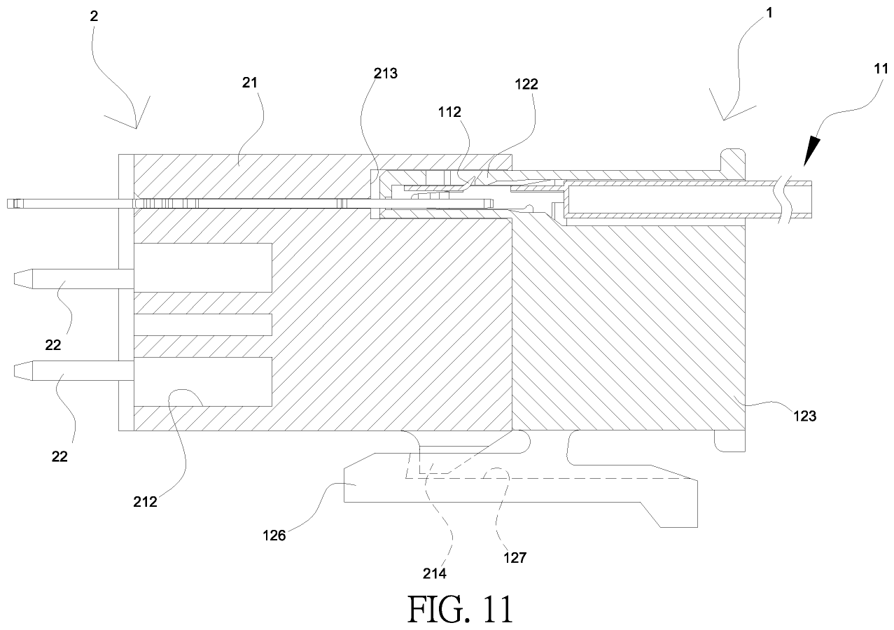

As shown in FIG. 10 and FIG. 11, in this case, the female end housing 12 is provided with a locking piece 126, the locking piece 126 is provided with a groove 127, the male end housing 21 is provided with a locking block 214 corresponding to the groove 127.

When the female end connecting piece is inserted in the male end connecting piece, as shown in FIG. 11, the groove 127 in the locking piece 126 of female end connecting piece is connected to the locking block 214 of male end connecting piece, preventing the connection between the connector male end piece 2 and the connector female end piece 1 from getting loose, the structural stability of connector is guaranteed.

I claim:

1. A connector female end piece for preventing terminals from falling off, comprising
a female end housing and a female end terminal,
wherein the female end housing includes a female end terminal slot, and an upper end of the female end housing has a spring tab, the spring tab is located above the female end terminal slot, the female end terminal is provided with an opening, the female terminal is provided with a hook on a side of the opening; the female terminal is inserted into the female terminal slot, the side of the hook is opposite to the side of the spring tab, and the opening of the female terminal is located below the spring tab of female end housing;
when the female terminal is pulled out, the hook pushes against the spring tab to sink and engage with the opening of the female terminal.

2. The connector female end piece for preventing terminals from falling off according to claim 1, wherein the side of the hook and the side of the spring tab are inclined surfaces that match each other.

3. The connector female end piece for preventing terminals from falling off according to claim 1, wherein the female end housing includes a female end housing main body, a female end pin component and a spring tab housing, the female end pin component is disposed at a front end of the female end housing main body, the spring tab housing is disposed at a top end of the female end housing main body, the spring tab housing is provided with a female end terminal slot, the spring tab is installed on the spring tab housing.

4. A connector for preventing terminals from falling off, comprising
a connector female end piece and a connector male end piece,
wherein the connector female end piece is as described in claim 1,
the connector male end piece includes a male end housing and a male end terminal, the male end terminal is assembled on the male end housing, the connector female end piece is inserted in the connector male end piece, and the male end housing presses against the spring tab and sinks to engage with the opening of female end terminal.

5. The connector preventing terminals from falling off according to claim 4, wherein the male end housing includes a male end housing main body, the male end housing main body is provided with a pin slot and a spring tab housing slot, the spring tab housing slot is located at an upper end of the pin slot.

6. The connector preventing terminals from falling off according to 4, the female end housing is provided with a locking piece, the locking piece is provided with a groove, the male end housing is provided with a locking block corresponding to the groove.
